(19) United States
(12) Patent Application Publication
(10) Pub. No.: US 2015/0373230 A9
(43) Pub. Date: Dec. 24, 2015

(54) NETWORKED PROGRAMMABLE TIMECODE AND METADATA TRANSFER SYSTEM

(71) Applicant: TIMECODE SYSTEMS LTD, Worcester (GB)

(72) Inventor: Paul Scurrell, Worcester (GB)

(21) Appl. No.: 13/948,252

(22) Filed: Jul. 23, 2013

Related U.S. Application Data
(60) Provisional application No. 61/674,783, filed on Jul. 23, 2012.

(51) Int. Cl. H04N 5/04

(52) U.S. Cl. CPC H04N 5/04

(57) ABSTRACT

A networked, multi-channel, and bi-directional programmable datalink timecode system including a generator apparatus that connects to and provides timecode, genlock, metadata, and streaming audio and video images to networked devices via wired and wireless networks. System includes software on a computer hardware device capable of connecting to and receiving streaming timecode, metadata, and streaming audio and video images from a generator apparatus. System also includes a datalink transceiver apparatus that connects to and receives timecode, genlock, metadata, and streaming audio from a generator apparatus.

### FIELD OF ART

The present invention generally relates to audio and video processing systems. More particularly, the invention relates to methods for synchronizing audio and video signals using timecode and metadata.

### PRIOR ART

The following is a list of some prior art that presently appears relevant:

### PATENT NUMBER

U.S. Pat. No. 8,019,194
U.S. Pat. No. 7,933,203
U.S. Pat. No. 7,913,157
U.S. Pat. No. 7,881,587
U.S. Pat. No. 7,743,161
U.S. Pat. No. 7,673,316
U.S. Pat. No. 7,633,551
U.S. Pat. No. 7,609,608
U.S. Pat. No. 7,593,619
U.S. Pat. No. 7,555,196
U.S. Pat. No. 7,552,193
U.S. Pat. No. 7,436,899
U.S. Pat. No. 7,398,411
U.S. Pat. No. 7,324,743
U.S. Pat. No. 7,321,601
U.S. Pat. No. 7,200,320
U.S. Pat. No. 7,024,155
U.S. Pat. No. 5,892,552
U.S. Pat. No. 5,557,423

### BACKGROUND

Modern audio and video processing systems typically utilize multiple cameras for simultaneous audio and video recording of their subjects. In order for the recordings to be effectively utilized in post-production where all of the raw recording materials are edited into a final recording, the audio and video signals from all cameras must be carefully synchronized. Without this synchronization, the audio and video signals from one camera at a given point in time may not properly align with the audio and video signals from a second camera. For example, the background noise of a train passing quickly through one camera's field of vision could be caught at a different perceived point in time on a second camera, thus resulting in one camera identifying the train and its associated sounds at time point 00:01:10:15 (00 hour:01 minute:10 second:15 frame), whereas the second camera might capture the moving train at point 00:01:13:25, thus potentially resulting in no train even being shown or heard by the second camera if both cameras' recordings are set to the first camera's 00:01:10:15 to 01:12:30 range of time as the basis for post-production of the train's movements.

Existing timecode technology allows for the audio and video recordings of multiple cameras to be synchronized, but the equipment used for such synchronization has limited functionality. For example, current systems require each generator to be manually synchronized and periodically re-synchronized. They also require equipment with the correct input sockets..

The present invention solves the need for more flexible and scalable timecoding technologies by allowing a user to stream accurate timecode information over a wireless network such as Wi-Fi to mobile devices such as iPhones or iPads, giving everyone from camera assistants to script supervisors and directors access to the same synchronized timecode. Accurate timecode can be utilized by other devices on the network. The present invention also allows timecode and metadata to pass directly between networked devices using an alternative wireless datalink.

### SUMMARY OF THE INVENTION

Embodiments of the present invention comprise methods and systems for providing timecode, genlock, metadata, streaming audio and video capture to networked devices via wired and wireless networks. In one embodiment, a user wanting to synchronize his camera or actions to a master timecode signal begins by turning on a timecode generator. This generator then emits a timecode signal that includes timecode, genlock, and metadata information. This information is received by a transceiver than can then retransmit the synchronized timecode signal to other transceivers including mobile devices running a software application designed to receive and interact with such a signal.

This exemplary embodiment is mentioned not to limit or define the invention, but to provide an example of an embodiment of the invention to aid understanding thereof.

### BRIEF DESCRIPTION OF THE DRAWINGS

These and other features, aspects, and advantages of the present invention are better understood when the following detailed description is read with reference to the accompanying drawings, wherein:

FIG. 1 is a schematic illustrating an exemplary network environment in which one embodiment of the present invention may operate.

### DETAILED DESCRIPTION OF EMBODIMENTS

The present invention provides methods for providing timecode, genlock, metadata, and streaming audio to networked devices via wired and wireless networks systems.

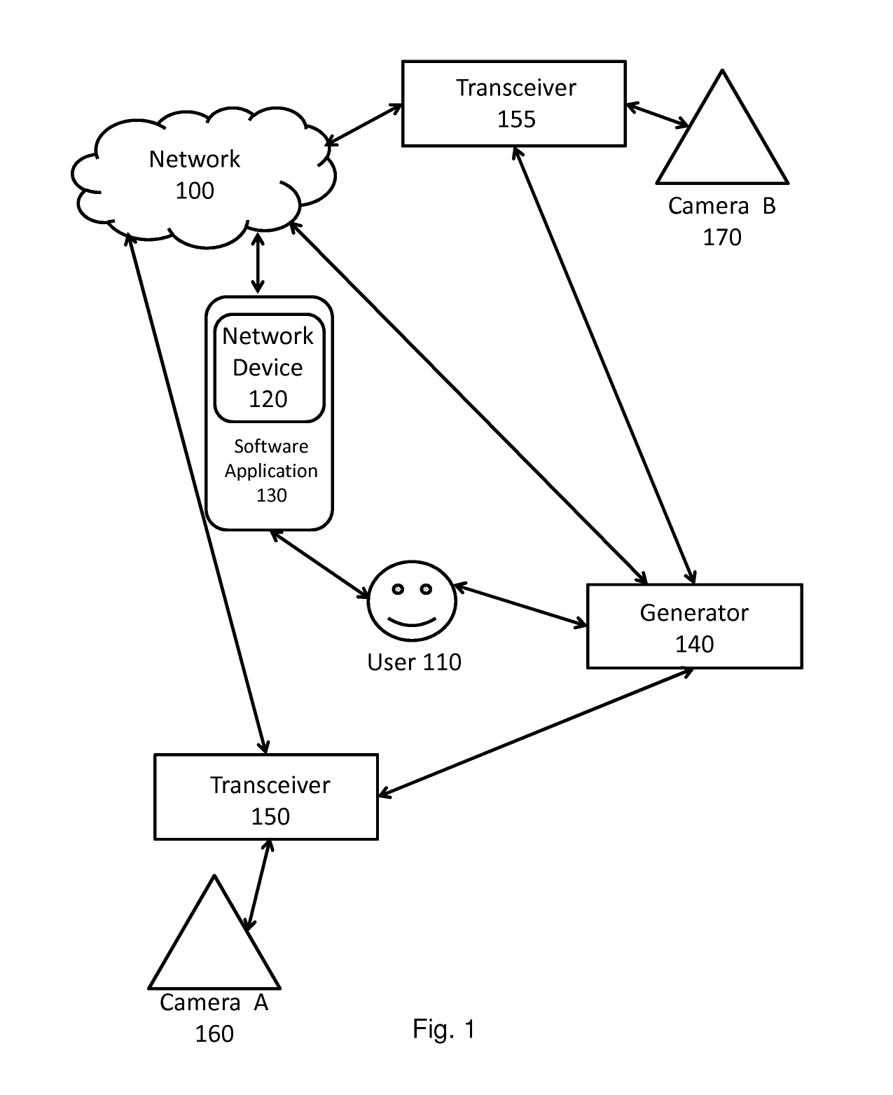

FIG. 1 is a schematic illustrating an exemplary logical environment in which one embodiment of the present invention may operate. Network 100 provides network access to the other elements of the environment. The network access may be wired or wireless, and may connect to the Internet or some other type of network or service such as a cloud computing service. A network may be part of a larger network that provides network access to the elements of the environment.

User 110 can access the Generator 140 or Network Device 120 that is connected to Network 100. User 110 is a person. Network Device 120 can be a computer, a mobile phone, a handheld tablet device, or any other mobile network device capable of accessing Network 100. Network Device 120 is running Software Application 130. Software Application 130 is able to receive and utilize the timecode data and the streaming audio and video data created and transmitted by Generator 140. Transceiver 150 is able to receive and transmit data transmitted by Generator 140 via a re-transmitted data stream. Generator 140 and Transceiver 155 may be provided in a single physical device. Camera A 160 is able to receive timecode, genlock and audio data created and transmitted by Generator 140 through Transceiver 150. Camera A may be controlled by Software Application 130. Generator 140 and Transceiver 150 may be provided in a single physical device. Camera B 170 is able to receive timecode, genlock and audio data created and transmitted by Generator 140 through Transceiver 155. Camera A may be controlled by Software Application 130.

The invention claimed is:

1. A computer implemented system providing timecode, genlock, metadata, and streaming audio and video images to networked and direct RF datalinked devices, comprising:
A networked, multi-channel, and bi-directional programmable timeclock generator that connects to and provides timecode, genlock, metadata, and streaming audio and video to networked devices via wired and wireless networks;
A software application capable of connecting to and receiving streaming timecode, metadata, and streaming audio and video from a generator; and
A networked, multi-channel, and bi-directional programmable datalink transceiver apparatus that connects to and receives timecode, genlock, metadata, and streaming audio and video from a generator.

2. A computer implemented method providing timecode, genlock, metadata, and streaming audio and video images to networked and direct RF datalinked devices, comprising:
A networked, multi-channel, and bi-directional programmable timeclock generator that connects to and provides timecode, genlock, metadata, and streaming audio and video to networked devices via wired and wireless networks;
A software application capable of connecting to and receiving streaming timecode, metadata, and streaming audio and video from a generator; and
A networked, multi-channel, and bi-directional programmable datalink transceiver apparatus that connects to and receives timecode, genlock, metadata, and streaming audio and video from a generator.

3. The system of claim 1, further comprising the ability to operate where the system connects to an existing wired network connected to the Internet.

4. The system of claim 1, further comprising the ability to operate where the system connects to an existing wireless network connected to the Internet.

5. The system of claim 1, further comprising the ability to operate where the system connects to the Internet via a cloud-based Internet service.

6. The system of claim 1, wherein the networked, multi-channel, and bi-directional programmable timeclock generator connects to and provides timecode, genlock, metadata, and streaming audio and video to networked devices connected to the Internet via a cloud-based Internet service.

7. The system of claim 1, wherein the software application capable of connecting to and receiving streaming timecode, metadata, and streaming audio and video from a generator is connected to the Internet via a cloud-based Internet service.

8. The system of claim 1, wherein the networked, multi-channel, and bi-directional programmable datalink transceiver apparatus connects to and receives timecode, genlock, metadata, and streaming audio and video from a generator connected to the Internet via a cloud-based Internet service.

9. The method of claim 2, further comprising the ability to operate where the system connects to an existing wired network connected to the Internet.

10. The method of claim 2, further comprising the ability to operate where the system connects to an existing wireless network connected to the Internet.

11. The method of claim 2, further comprising the ability to operate where the system connects to the Internet via a cloud-based Internet service.

12. The method of claim 2, wherein the networked, multi-channel, and bi-directional programmable timeclock generator connects to and provides timecode, genlock, metadata, and streaming audio and video to networked devices connected to the Internet via a cloud-based Internet service.

13. The method of claim 2, wherein the software application capable of connecting to and receiving streaming timecode, metadata, and streaming audio and video from a generator is connected to the Internet via a cloud-based Internet service.

14. The method of claim 2, wherein the networked, multi-channel, and bi-directional programmable datalink transceiver apparatus connects to and receives timecode, genlock, metadata, and streaming audio and video from a generator connected to the Internet via a cloud-based Internet service.
